(19) United States
(12) Patent Application Publication
(10) Pub. No.: US 2017/0303119 A1
(43) Pub. Date: Oct. 19, 2017

(54) INFORMATION PROCESSING SYSTEM, METHOD OF OBTAINING MONITOR INFORMATION, AND SENSOR DEVICE

(71) Applicant: FUJITSU LIMITED, Kawasaki-shi (JP)

(72) Inventors: Takao Ogura, Yokohama (JP); Ikuya Morikawa, Kawasaki (JP)

(73) Assignee: FUJITSU LIMITED, Kawasaki-shi (JP)

(21) Appl. No.: 15/431,943

(22) Filed: Feb. 14, 2017

(30) Foreign Application Priority Data
Apr. 15, 2016 (JP) 2016-082533

(51) Int. Cl. H04W 12/02; H04L 29/06; G06F 21/62; G06F 21/60; G06F 19/00; H04W 12/04

(52) U.S. Cl. CPC H04W 12/02; H04W 12/04; H04L 63/0492; G06F 19/322; G06F 21/606; G06F 19/3418; G06F 21/6245

(57) ABSTRACT

An information processing system includes an information processing device including a processor, an electronic tag configured to store first identification information used for identifying a monitor target, and a sensor device configured to acquire first monitor information of the monitor target, wherein the processor is configured to transmit, to the sensor device and a server device, a first encryption key corresponding to the first identification information, and transmit, to the sensor device and a server device, second identification information used for identifying the first encryption key, and the sensor device is configured to acquire the first identification information from the electronic tag, encrypt the first monitor information using the first encryption key that corresponds to the first identification information, and transmit, to the server device, the encrypted first monitor information and the second identification information.

### CROSS-REFERENCE TO RELATED APPLICATION

This application is based upon and claims the benefit of priority of the prior Japanese Patent Application No. 2016-082533, filed on Apr. 15, 2016, the entire contents of which are incorporated herein by reference.

### FIELD

The embodiments discussed herein are related to an information processing system, a method of obtaining monitor information, and a sensor device.

### BACKGROUND

Conventionally, a system in which, for health maintenance and management, information related to a state of a user is acquired from a sensor and is stored in a database coupled to a communication line, the information stored in the database is read out by a terminal device of the user, and thus, health management or the like is performed has been known. For example, a mobile terminal device that acquires biological information, such as body temperature, blood pressure, or the like, of a user using a sensor that is capable of communicating with a mobile terminal, encrypts the acquired biological information using a public key that corresponds to a secret key provided to the mobile terminal, and transmits the information to the database has been known. Data encrypted and thus stored in the database is read out by a mobile terminal of the user or a terminal of the user, is decrypted using the secret key that the user has, and thus is used. As a related art document, there is Japanese Laid-open Patent Publication No. 2005-245833.

### SUMMARY

According to an aspect of the invention, an information processing system includes an information processing device including a memory and a processor coupled to the memory, an electronic tag configured to store first identification information used for identifying a monitor target, and a sensor device configured to acquire first monitor information of the monitor target, wherein the processor is configured to transmit, to the sensor device and a server device, a first encryption key corresponding to the first identification information, and transmit, to the sensor device and a server device, second identification information used for identifying the first encryption key, and the sensor device is configured to acquire the first identification information from the electronic tag, encrypt the first monitor information using the first encryption key that corresponds to the first identification information, and transmit, to the server device, the encrypted first monitor information and the second identification information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system configuration;

FIG. 2 is a diagram illustrating an example of a hardware configuration of a sensor device;

FIG. 3 is a diagram illustrating an example of a hardware configuration of a token management terminal;

FIG. 4 is a diagram illustrating an example of a hardware configuration of a computer included in a cloud server;

FIG. 5 is an exemplary functional block diagram illustrating processing that is executed by a sensor device, a token management terminal, and a cloud server according to a first embodiment;

FIG. 6 is a diagram illustrating an example of control information stored in a sensor device, a token management terminal, and a cloud server according to the first embodiment;

FIG. 7 is a diagram illustrating an example of processing of transmitting monitor information acquired by a sensor device to a cloud server;

FIG. 8 is a diagram illustrating an example of a sequence in which monitor information is acquired using a sensor device and is transmitted to a cloud server;

FIG. 9 is a flowchart illustrating an example of processing that is performed by a sensor device;

FIG. 10 is a flowchart illustrating an example of processing that is performed by a token management terminal;

FIG. 11 is a flowchart illustrating an example of processing that is performed by a cloud server;

FIG. 12 is a diagram illustrating an example of a token storage unit and a token management table in a second embodiment;

FIG. 13 is a flowchart illustrating an example of processing that is performed by a sensor device in the second embodiment;

FIG. 14 is a flowchart illustrating an example of processing that is performed by a token management terminal according to the second embodiment;

FIG. 15 is a diagram illustrating another example of a hardware configuration of a sensor device; and

FIG. 16 is a diagram illustrating an example of a sequence when a cloud server issues a token (a token ID and an encryption key) which corresponds to a user.

### DESCRIPTION OF EMBODIMENTS

In recent years, in a facility, such as a hospital, a medical center, or the like, a system that electrically manages medical charts of patients, measurement data related to the states of the patients has come into wide use. Now, it is considered to store biological information, such as body temperature, blood pressure, or the like, of a patient which is acquired from the patient on a daily basis, in a server that provides a cloud service and to use the biological information.

In the above-described known technology, when measurement data of a patient is transmitted to a server, a mobile terminal that has received the measurement data from a sensor device performs a communication with a database using an encryption key specific to the mobile terminal, and thus, confidentiality of measured private information from a data transmission user is maintained. However, in a facility, such as a hospital or the like, there may be a case where a device, such as a mobile phone, which generates a strong electric wave, adversely affects medical devices. Also, it is not realistic to prepare an individual mobile phone for each patient. Therefore, it is conceivable to install, in a facility, such as a hospital or the like, a gateway that performs a short-range wireless communication with a weak electric wave in each room and thus perform a wireless communication between a sensor device and the gateway.

For a wireless communication used for performing a communication between devices in a short range, for example, a communication method, such as Bluetooth (registered trademark), wireless fidelity (WiFi), or the like, in which an encrypted communication is established by performing paring processing of exchanging an encryption key, is used. Therefore, it is conceivable to mount a communication interface that is capable of performing an encrypted communication in the sensor device and thus perform an encrypted communication between the gateway coupled to a network and the sensor device.

However, paring processing is performed by inputting the same number to both of devices that perform a communication with one another, tapping, if in a communication with a smart phone, or the like. If paring is performed only once between the sensor device and the gateway, no big problem arises but, if various sensors are used in a plurality of hospital rooms and for a plurality of patients, a problem arises in which it takes labor and time for setup for performing a communication. Therefore, it is desirable to safely transmit measurement data to a server using a wireless communication line that does not perform paring processing used for encrypting a communication.

In embodiments described below, using as an example a case where various types of biological information, such as body temperature, blood pressure, or the like, are acquired from a patient in a hospital, a system that transmits information acquired from a monitor target to a cloud server while ensuring confidentiality of data will be described as an example. However, the contents of the present disclosure are not limited to embodiments applied to use in a hospital, which will be described below, but the present disclosure may be applied to various different monitor targets and various types of monitor information. Embodiments will be described below with reference to the accompanying drawings.

### First Embodiment

[System Configuration]

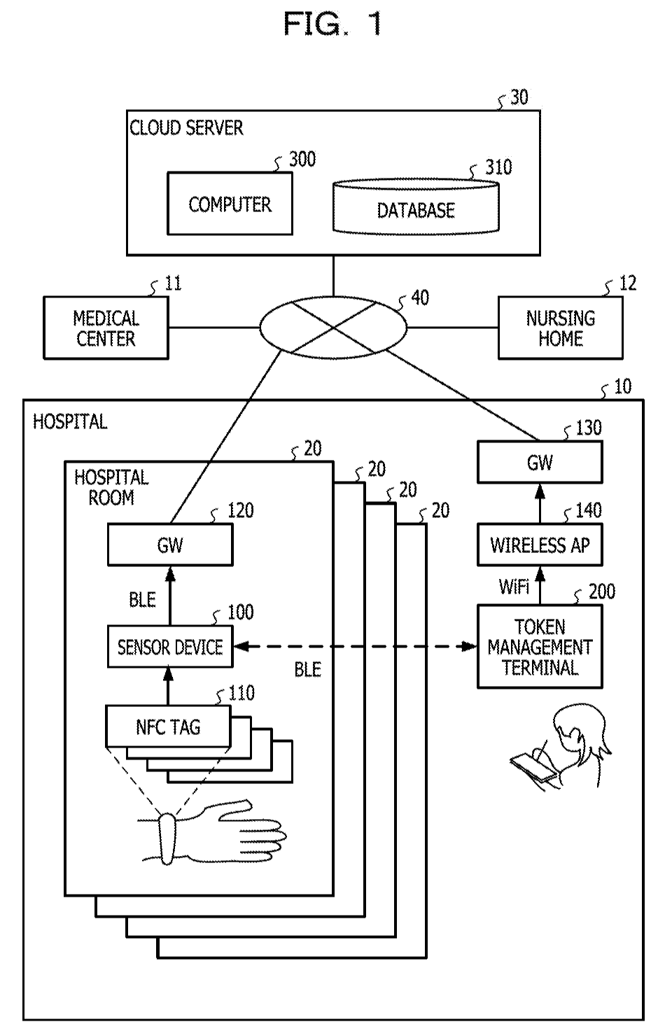

FIG. 1 is a diagram illustrating an example of a system configuration according to a first embodiment. In the example of a system configuration illustrated in FIG. 1, a hospital 10, a medical center 11, and a nursing home 12 are coupled to a cloud server 30 via a network 40. The hospital 10, the medical center 11, and the nursing home 12 are examples of a facility which acquires various types of biological information from a monitor target, such as a patient or the like, and this embodiment may be applied to some other facility. The cloud server 30 is a server that provides a so-called cloud service, and is a server device that is coupled to a network environment and performs processing on received data or request.

The hospital 10 has a plurality of hospital rooms 20 and, in each hospital room, a plurality of patients has a medical treatment or a medical examination. In each of the hospital rooms 20, biological information, such as body temperature, blood pressure, pulse, or electro cardiogram, of each of the plurality of patients is regularly measured by a nurse using a sensor device 100. The patient is an example of monitor targets and biological information measured from each patient is an example of monitor information.

The sensor device 100 encrypts the measurement data, such as body temperature or the like, of each patient, which has been measured in order to conceal the measurement data and thus transmit the concealed data to a cloud server 30. A token management terminal 200 is, for example, a terminal device that is carried by a nurse or the like who performs a measurement for each patient and generates a token including an encryption key used for encrypting measurement data and a token ID that is key identification information used for identifying the encryption key.

A gateway (GW) 120 used for performing a communication with the cloud server 30 via the network 40 is installed in each of the hospital rooms 20. The sensor device 100 and the gateway 120 are coupled with one another via a wireless communication line, such as Bluetooth Low Energy (BLE) or the like, and the sensor device 100 and the token management terminal 200 are coupled with one another via a wireless communication line, such as Bluetooth Low Energy (BLE) or the like. Also, the token management terminal 200 is coupled to a wireless access point (AP) 140 and a gateway (GW) 130 via a communication line, such as wireless fidelity (WiFi) or the like.

While each patient is admitted to the hospital 10 or has an examination in the hospital 10, the patient wears a tag, such as a near field communication (NFC) tag or the like, which used for a short-range wireless communication around a wrist or put the tag on a clothing that the patient wears in the hospital. An NFC tag 110 is a device that stores tag data, such as a user ID or the like, which is identification information set for each patient. When a regular measurement of the body temperature, blood pressure, or the like of the patient is performed, the user ID stored in the NFC tag 110 is read out by an NFC tag reader or the like mounted in the sensor device 100.

The token management terminal 200 generates a token used for encrypting measurement data for each of the user IDs of the patients in accordance with a token generation request from the sensor device 100, an operation of a nurse, or the like. The token management terminal 200 notifies the cloud server 30 of the generated token via the wireless AP 140 and the gateway 130. Also, the token management terminal 200 notifies the sensor device 100 of the generated token.

The sensor device 100 performs measurement for a patient using a sensor, such as a thermometer or the like. The sensor device 100 encrypts biological data measured from the patient using a token received from the token management terminal 200 and transmits the encrypted biological data to the cloud server 30 via the gateway 120.

The cloud server 30 decrypts the encrypted data transmitted from the sensor device 100 using the token notified from the token management terminal 200 in advance. The cloud server 30 processes the measurement data of the patient, which has been decrypted, such that the measurement data may be visualized, and stores the processed data in a database 310. The measurement data stored in the database 310 is used for health management performed by the patient or for diagnosis by a doctor.

[Hardware Configuration]

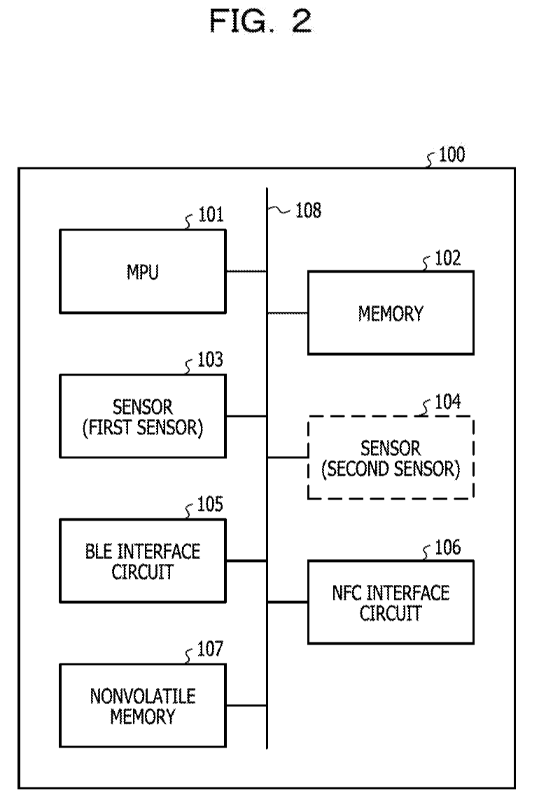

FIG. 2 is a diagram illustrating an example of a hardware configuration of the sensor device 100. The sensor device 100 includes a micro-processing unit (MPU) 101, memory 102, a first sensor 103, a second sensor 104, a BLE interface circuit 105, an NFC interface circuit 106, and a nonvolatile memory 107. The MPU 101 is coupled to another circuit, such as the memory 102 or the like, in the sensor device 100 via a bus 108.

The MPU 101 is an example of a processor that executes various types of processing which are performed by the sensor device 100, and is a hardware circuit. Instead of the MPU 101, a hardware circuit, such as a central processing unit (CPU), a field programmable gate array (FPGA), a sequencer circuit, or the like, may be also used.

The memory 102 is a storage device, such as random access memory (RAM) or the like. The memory 102 temporarily stores a program that is executed by the MPU 101 or measurement data measured by the sensor device 100. The MPU 101 executes the program stored in the memory 102, and thereby, each of the various types of processing which are performed by the sensor device 100, which will be described later, is executed.

Each of the first sensor 103 and the second sensor 104 is, for example, a sensor that is used for measuring biological information, such as body temperature, blood pressure, or the like of each patient. Examples of the sensors 103 and 104 include a thermometer, a sphygmomanometer, a pulse rate meter, a sensor that measures an electrocardiogram, and the like. In FIG. 2, an example in which two sensors, that is, the first sensor and the second sensor, are mounted in the sensor device 100 is illustrated as an example but, only a single sensor may be mounted therein, and also, three or more sensors may be mounted therein.

The BLE interface circuit 105 is an interface circuit through which the sensor device 100 performs a communication with the gateway 120 or the token management terminal 200 via a BLE wireless communication line. The NFC interface circuit 106 is an interface circuit through which the sensor device 100 acquires tag data from the NFC tag 110 using an NFC short-range wireless communication. The NFC interface circuit 106 is an example of the NFC tag reader.

The nonvolatile memory 107 is a storage circuit that is used for storing a program that is executed by the MPU 101. The nonvolatile memory 107 may be also used for storing the user ID that is identification information of each patient and a token used for encrypting data measured from each patient.

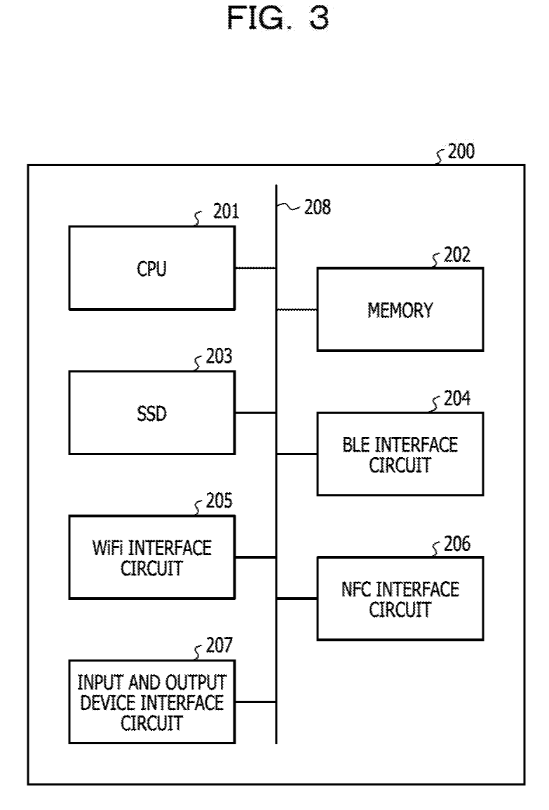

FIG. 3 is a diagram illustrating an example of a hardware configuration of the token management terminal 200. The token management terminal 200 includes a CPU 201, memory 202, a solid state disk (SSD) 203, a BLE interface circuit 204, a WiFi interface circuit 205, an NFC interface circuit 206, and an input and output device interface circuit 207. The CPU 201 is coupled to another component, such as the memory 202 or the like, via a bus 208.

The CPU 201 is an example of a hardware circuit of a processor that executes various types of processing which are performed by the token management terminal 200. Instead of the CPU 201, a hardware circuit, such as a field programmable gate array (FPGA), a sequencer circuit, or the like, may be also used.

The memory 202 is a storage device, such as RAM or the like. The memory 202 stores a program that is executed by the CPU 201, or a token including an encryption key that is used by the sensor device 100 when the sensor device 100 encrypts measurement data and a token ID that is key identification information used for identifying the encryption key. Also, the memory 202 stores a user ID that is identification information of a patient and information related to a sensor device used for measuring biological information of the patient in association with each token. The CPU 201 executes a program stored in the memory 202, and thereby, each of the various types of processing which are performed by the token management terminal 200, which will be described later, is executed.

The SSD 203 is a nonvolatile storage circuit used for storing data, such as a program that is executed by the token management terminal 200, or the like. The SSD 203 may be also used for storing identification information of each patient, a token (an encryption key and a token ID) which corresponds to each patient, and information related to a sensor device that is used for measuring biological information of each patient.

The BLE interface circuit 204 is an interface circuit through which the token management terminal 200 performs a communication with the sensor device 100 or the gateway 120 in each hospital room via the BLE wireless communication line. The WiFi interface circuit 205 is an interface circuit through which the token management terminal 200 performs a communication with the wireless AP 140 via a WiFi wireless communication line. The NFC interface circuit 206 is an interface circuit through which the token management terminal 200 acquires tag data from the NFC tag 110 of a patient using an NFC short-range wireless communication. The NFC interface circuit 206 is an example of the NFC tag reader.

The input and output device interface circuit 207 is an interface circuit couples various input and output devices, such as a touch pad input, a display output, or the like, which are used for processing that is performed in the token management terminal 200.

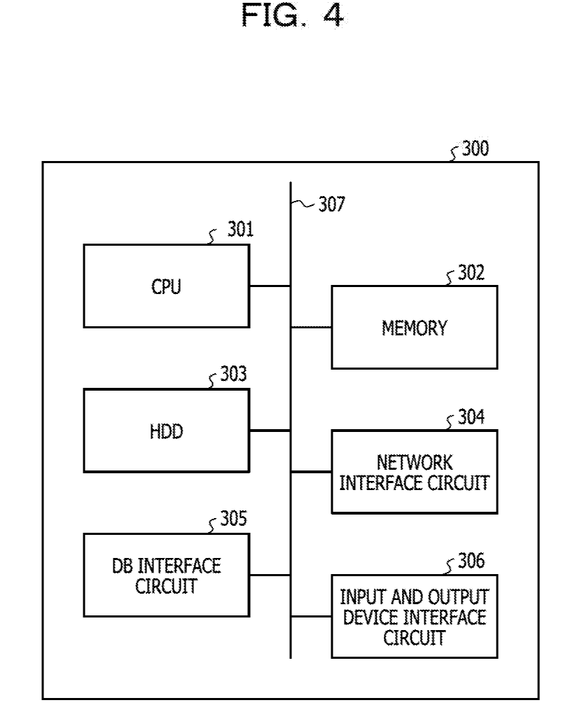

FIG. 4 is a diagram illustrating an example of a hardware configuration of a computer 300 included in the cloud server 30. The computer 300 includes a CPU 301, memory 302, a hard disk drive (HDD) 303, a network interface circuit 304, a database (DB) interface circuit 305, and an input and output device interface circuit 306.

The CPU 301 is an example of a hardware circuit of a processor that performs various types of processing of the cloud server 30 on the computer 300, and one of electronic parts that constitute the computer 300. Although, in the example of FIG. 4, an example in which the computer 300 includes a single CPU 301 is illustrated, the number of CPUs is not limited to one but the computer 300 may include a plurality of CPUs. As another alternative, the CPU 301 may include a plurality of CPU cores and a hardware thread, and a CPU that is capable of performing processing of processes of a plurality of applications in parallel by the single CPU itself may be used as the CPU 301.

The memory 302 is a storage device, such as RAM or the like. The memory 302 stores a program that is executed by the CPU 301 or data that is to be a target that is processed by the computer 300. The CPU 301 executes a program stored in the memory 302, and thereby, each of the various types of processing which are performed by the computer 300, which will be described later, is executed.

The hard disk drive (HDD) 303 is a nonvolatile storage medium that stores a program that is executed by the CPU 301 or data that is handled by processing that is executed on the CPU 301. The network interface circuit 304 is an interface circuit through which the computer 300 performs a communication with another device via the network 40.

The database (DB) interface circuit 305 is an interface circuit that is used for performing a communication with the database 310. In this case, the database (DB) 310 is a database device that stores data related to processing that is performed in the cloud server 30, and stores an operating system (OS) that is executed on the cloud server 30, data used by an application, or the like. Also, the DB 310 stores various types of data, such as measurement data of each patient, which have been received via a network. A DB sever 310 is realized by a storage device, a server including a large capacity storage device, or the like.

The input and output device interface circuit 306 is a circuit that is used for controlling, when a peripheral device, such as a mouse, a keyboard, or the like, is coupled to the computer 300, input and output to and from the peripheral device.

[Functional Block Diagram]

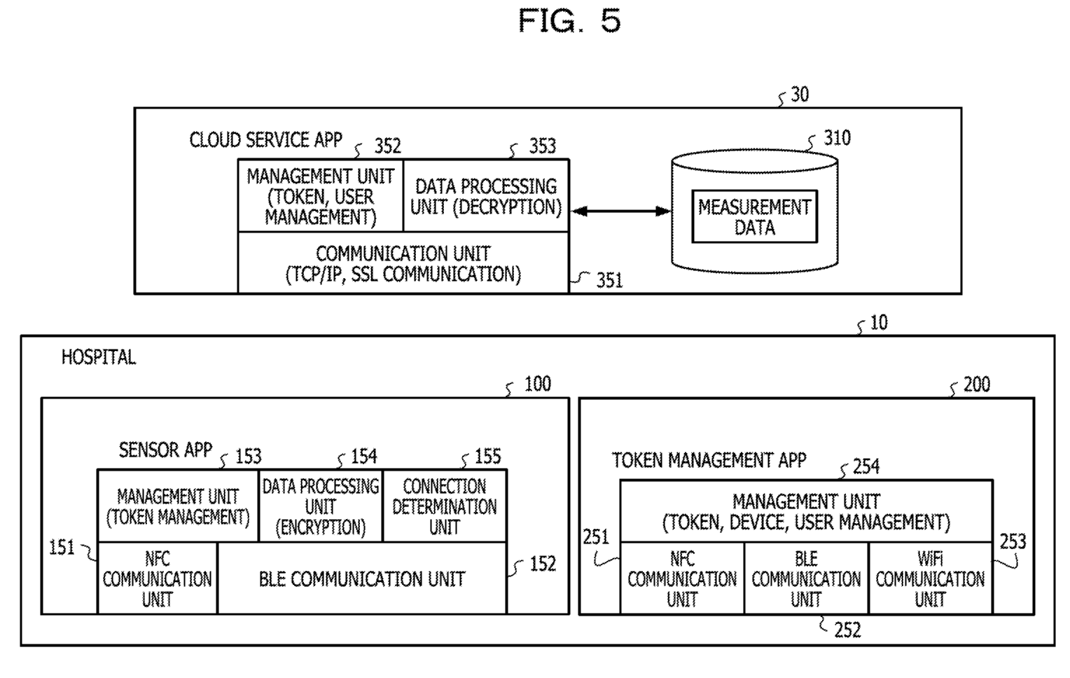

FIG. 5 is an exemplary functional block diagram illustrating processing that is executed by the sensor device 100, the token management terminal 200, and the cloud server 30 according to the first embodiment.

The sensor device 100 executes a sensor application program including each processing of an NFC communication unit 151, a BLE communication unit 152, a management unit 153, a data processing unit 154, and a connection determination unit 155. The MPU 101 executes a predetermined program stored in the memory 102 or the nonvolatile memory 107, and thereby, the sensor application program is executed.

The NFC communication unit 151 controls the NFC interface circuit 106 and reads out a user ID that identifies a patient (a user) from the NFC tag 110 worn by the patient via the NFC short-range wireless communication line. The BLE communication unit 152 controls the BLE interface circuit 105 and communicates with the token management terminal 200 or the gateway 120 via the BLE wireless communication line.

The management unit 153 controls overall processing in the sensor device 100. The management unit 153 performs a communication with the NFC tag 110 or the token management terminal 200 using the NFC communication unit 151 and the BLE communication unit 152 and manages a token generated by the token management terminal 200.

The data processing unit 154 encrypts measurement data measured from a patient (a user) by the sensor 103 using an encryption key generated for the user ID and generates transmission data including the encrypted data and the token ID that is used for identifying the encryption key. The transmission data, that is, the encrypted measurement data and the token ID, which has been generated by the data processing unit 154, is transmitted to the gateway 120 by the BLE communication unit 152, and then, is transmitted to the cloud server 30 via the gateway 120.

Note that, as an encryption key, an encryption key in accordance with a so-called public key cryptosystem may be used. The common key cryptosystem is an encryption method in which a “key” that is used by a device that performs encryption and a “key” that is used by a device that performs decryption are the same key. An encryption key may be generated by an arbitrary method and, for example, may be generated by generating a random number of a predetermined bit number.

The token ID is identification information that is used for identifying the generated encryption key, and may be generated by an arbitrary method. For example, each time an encryption key is generated, a token ID may be generated by generating a random number.

The token including the encryption key and the token ID is used in common in processing of encrypting data and processing of decrypting the encrypted data. Thus, each time data is measured from a patient using the sensor device 100, a new token may be generated and used for encryption and decryption of the measured data. A new token is used each time data is measured, and thereby, it is enabled to encrypt measurement data and thus transmit the measurement data more safely.

The connection determination unit 155 determines whether or not it is possible to execute a communication with the token management terminal 200 using the BLE communication unit 152 at the time when the sensor device 100 is used or on a regular basis. The connection determination unit 155 stores a result of determination on whether or not it is possible to execute a communication with the token management terminal 200, as information indicating “STATE” in a management terminal connection state table 170 which will be described later.

The token management terminal 200 includes an NFC communication unit 251, a BLE communication unit 252, a WiFi communication unit 253, and a management unit 254 and executes an application program that performs token management. The CPU 201 executes a program stored in the memory 202 or the SSD 203, and thereby, the application program that performs token management is executed.

The NFC communication unit 251 controls the NFC interface circuit 206 and reads out a user ID that identifies a patient from the NFC tag 110 worn by the patient via the NFC short-range wireless communication line. The BLE communication unit 252 controls the BLE interface circuit 204 and communicates with the sensor device 100 or the gateway 120 via the BLE wireless communication line. The WiFi communication unit 253 controls the WiFi interface circuit 205 and communicates with the wireless AP 140 via the WiFi wireless communication line.

The management unit 254 controls overall processing in the token management terminal 200. When the user ID that identifies the patient is acquired from the NFC tag of the patient by the NFC communication unit 251, the management unit 254 generates a token including an encryption key that corresponds to the acquired user ID and a token ID that is identification information that uniquely specifies the encryption key. The management unit 254 coupes to the wireless AP 140 using the WiFi communication unit 253 and transmits the generated token to the cloud server 30 via the wireless AP 140 and the gateway 130. Also, the management unit 254 transmits the generated token to the sensor device 100 using the BLE communication unit 252.

The cloud server 30 includes a communication unit 351, a management unit 352, and a data processing unit 353 and executes an application program of a cloud service. The CPU 301 executes a program stored in the memory 302 or the HDD 303, and thereby, the application program of the cloud service is executed.

The communication unit 351 performs a communication with another device via the network 40 in accordance with a TCP/IP protocol. When a device of a communication partner supports Secure Sockets Layer (SSL), the communication unit 351 performs an encrypted communication using SSL with the device of the communication partner. The management unit 352 performs management of a token that is received from the token management terminal 200.

The data processing unit 353 decrypts the encrypted measurement data that is received from the sensor device 100 using a corresponding encryption key included in a token that has been received in advance. The data processing unit 353 performs predetermined processing for visualization of data on the decrypted measurement data and stores the measurement data on which the processing has been performed in the database 310.

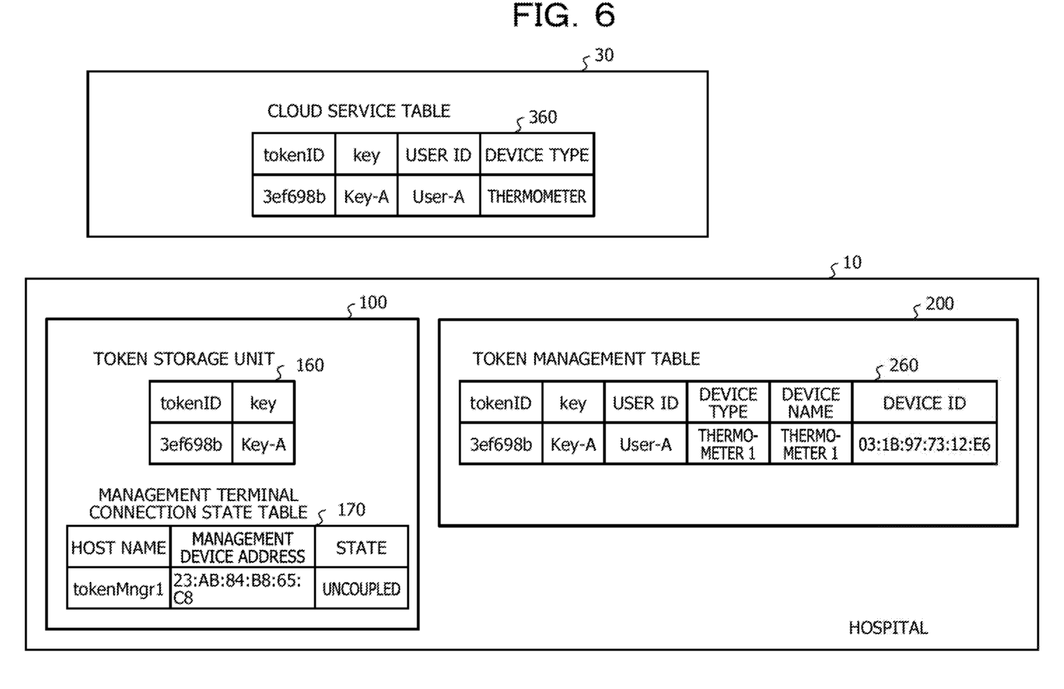

FIG. 6 is a diagram illustrating an example of control information that is stored in the sensor device 100, the token management terminal 200, and the cloud server 30 according to the first embodiment. The sensor device 100 includes a token storage unit 160 and the management terminal connection state table 170. The token storage unit 160 is a storage unit that stores information (a token ID (tokenID) and an encryption key (key)) of a token that corresponds to a monitor target for which the sensor device 100 performs measurement. In the example of FIG. 6, in the token storage unit 160, “3ef698b” is stored as a token ID and “Key-A” is stored as an encryption key.

The management terminal connection state table 170 is a storage unit that stores information related to “STATE” indicating whether or not the sensor device 100 is coupled to the token management terminal 200 via the BLE wireless communication line or the like. In items of “HOST NAME” and “MANAGEMENT TERMINAL DEVICE ADDRESS” in the management terminal connection state table 170, information, such as, for example, the host name (“tokenMngr1”) of the token management terminal 200 that was coupled to the sensor device 100 last and the address (“23:AB:84:B8:65:C8”) of BLE, is stored.

In the item of “STATE” in the management terminal connection state table 170, for example, a result of determination on whether or not it is possible to couple the connection determination unit 155 to the token management terminal 200 via the BLE wireless communication line on a regular basis is stored. In the example of FIG. 6, the token management terminal 200 the host name of which is “tokenMngr1” is in a state of “UNCOUPLED”.

The token management terminal 200 includes a token management table 260. The token management table 260 is a storage unit that stores information, such as a token (a token ID (tokenID) and an encryption key (key)) that corresponds to a monitor target on which the sensor device 100 performs a measurement, identification information (a user ID) of a monitor target, a device ID that is used for identifying the sensor device 100, or the like.

In the example of FIG. 6, the encryption key “Key-A” and the token ID “3ef698b” are stored in association with the user ID “User-A” in the token management table 260. Also, information (a device type, a device name, and a device ID) related to the sensor device 100 that performs a measurement for a patient the user ID of which is “User-A” is also stored in association with the user ID “User-A” in the token management table 260. The token management table 260 illustrated in FIG. 6 illustrates an example in which information related to a single user ID is stored, but a plurality of sets of information each of which corresponds to the corresponding one of the user IDs of a plurality of patients, which are simultaneously measured, may be stored therein.

The cloud server 30 includes a cloud service table 360. The cloud service table 360 is a storage unit that stores a token including an encryption key that is used for decrypting encrypted data which is received from the sensor device 100 and a token ID that is used for identifying the encryption key in association with information, such as a user ID, the device type of the sensor device 100, or the like. The number of pieces of information related to a token that is stored in the cloud service table 360 is not limited to one. When the cloud server 30 receives pieces of encrypted data from a plurality of different sensor devices 100, a plurality of tokens each of which corresponds to the corresponding one of the plurality of sensor devices 100 is stored in the cloud service table 360.

[Processing Flow]

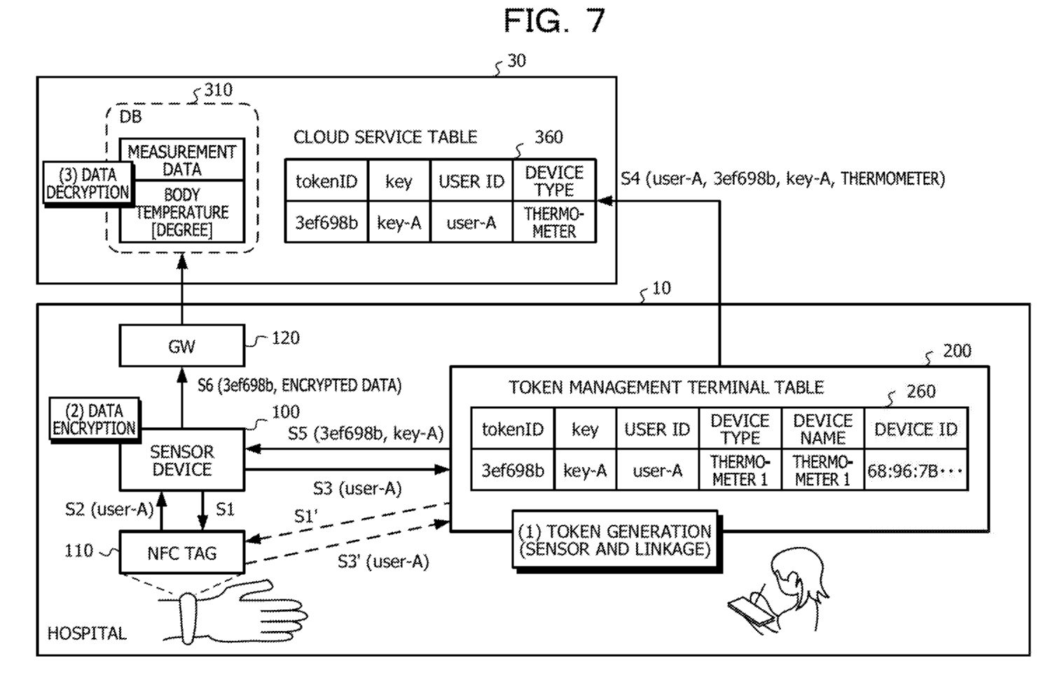

FIG. 7 is a diagram illustrating an example of processing of transmitting monitor information acquired by a sensor device to a cloud server. Processing illustrated in FIG. 7 is largely divided into three processes. The processing will be specifically described below in accordance with a flow of data.

(1) Generate Token and Link Sensor and User

First, the sensor device 100 performs a short-range wireless communication with the NFC tag 110 of a patient that is a measurement target of the sensor by NFC (S1), and reads out a user ID (“user-A”) that is the identification information of the patient from the NFC tag 110 (S2). The sensor device 100 transmits a token generation request to the token management terminal 200 via a wireless communication line, such as BLE or the like (S3). In that case, the sensor device 100 transmits information of a user ID (“user-A”), the device identification information (a device ID) of the sensor that measures data from the patient, or the like, to the token management terminal 200.

When the token management terminal 200 receives the token generation request from the sensor device 100, the token management terminal 200 generates an encryption key (“key-A”) that corresponds to the identification information of the patient, which has been received, and a token ID (“3ef698b”) as key identification information that is used for identifying the encryption key. The token management terminal 200 registers the encryption key and token ID that have been generated with the identification information (“user-A”) of the patient, which has been received from the sensor, and information related to the identification information of the sensor, or the like in the token management table 260.

The token management terminal 200 transmits a token including the token ID (“3ef698b”) and the encryption key (“key-A”) that have been generated to the cloud server 30 via the wireless AP 140, the GW 130, or the like (S4). The token management terminal 200 may be configured to transmit, in that case, the user ID (“user-A”) and information related to the type (for example, “THERMOMETER”) of the sensor device that performs a measurement with the token to the cloud server 30. Note that the user ID and the information related to the type of the sensor device may be encrypted with the measurement data and thus be included in the encrypted data that is generated by the sensor device 100.

The cloud server 30 responds to the token management terminal 200, indicating that information, such as the token ID, the encryption key, or the like, which has been received from the token management terminal 200, has been registered in the cloud service table 360 and has been correctly received. When the token management terminal 200 receives, from the cloud server 30, a response indicating that the information has been correctly received, the token management terminal 200 transmits the token ID (“3ef698b”) and the encryption key (“key-A”) that have been generated to the sensor device 100 (S5). When the sensor device 100 receives, from the token management terminal 200, the information of the token (the token ID, the encryption key) of the patient that is a measurement target, the sensor device 100 stores the information of the token which has been received in the token storage unit 160.

By processes of S1 to S5 of FIG. 7, generation of a token that corresponds to the patient that is to be a measurement target and linkage of the sensor device and the user (the patient) to one another are performed. That is, both of the sensor device 100 and the cloud server 30 share information of the token (the token ID, the encryption key) of the patient that is a measurement target.

(2) Encryption of Measurement Data

The sensor device 100 measures information, such as body temperature or the like, from the patient using the sensor 103. The sensor device 100 encrypts the measurement data measured from the patient using the encryption key received from the token management terminal 200 and generates encrypted data. The sensor device 100 transmits transmission data including the generated encrypted data and the corresponding token ID (“3ef698b”) to the cloud server 30 via the gateway 120 (S6).

(3) Decryption of Encrypted Data

When the cloud server 30 receives the encrypted data and the token ID (“3ef698b”), the cloud server 30 acquires the encryption key (“key-A”) that corresponds to the received token ID from the cloud service table 360. The cloud server 30 decrypts the encrypted data received from the sensor device 100 using the acquired encryption key (“key-A”). The cloud server 30 stores the decrypted measurement data in the database 310. The cloud server 30 may be configured to perform, in that case, processing for visualization, as appropriate, and store the processed data in the database 310.

By the above-described processing described in (1) and (2), it is enabled to encrypt measurement data measured from a patient using a specific encryption key generated in accordance with a user ID and thus transmit the encrypted measurement data to the cloud server 30. Then, in the processing of (3), in the cloud server 30, the encrypted measurement data may be decrypted using the specific encryption key that corresponds to the token ID which has been acquired from the token management terminal 200 in advance. By the above-described processing of (1) to (3), the measurement data that has been measured from the patient may be safely transmitted to the cloud server 30.

Note that, in the first embodiment, a configuration in which, each time the sensor device 100 measures data from a patient, a token generation request is given to the token management terminal 200, a new token is acquired, and information stored in the token storage unit 160 is updated may be employed. In this case, a specific token that is used only once is generated each time data is measured from the patient. Therefore, the token storage unit 160 in the first embodiment does not store the user ID and the confidentiality of the measurement data acquired from the patient is increased.

The token management terminal 200 may be configured to acquire information of the user ID, by processes of S1′ and S3′, instead of the processes of S1 to S3, in processing of token generation and sensor and user linkage illustrated in (1) of FIG. 7. That is, a configuration in which, instead of processing of reading out the NFC tag 110 performed by the sensor device 100, the token management terminal 200 reads out the user ID directly from the NFC tag 110 of a patient using the NFC interface circuit 206 may be employed. In this case, the token management terminal 200 links the device ID of the sensor device 100 that measures data of the patient that is a target, among the sensor devices 100 coupled thereto via the BLE communication line at that time, to the user ID. When a plurality of sensor devices is coupled to the token management terminal 200, for example, a selection screen may be output to a touch panel of the token management terminal 200 and a sensor device 100 that is to be linked may be determined based on a selection result input through the selection screen.

When the token management terminal 200 acquires the identification information of the user ID from the NFC tag 110, the token management terminal 200 generates a corresponding token and transmits the token to the sensor device 100 that is used for measuring data of a patient. The sensor device encrypts measurement data using the token acquired from the token management terminal 200 and transmits the encrypted measurement data to the cloud server 30.

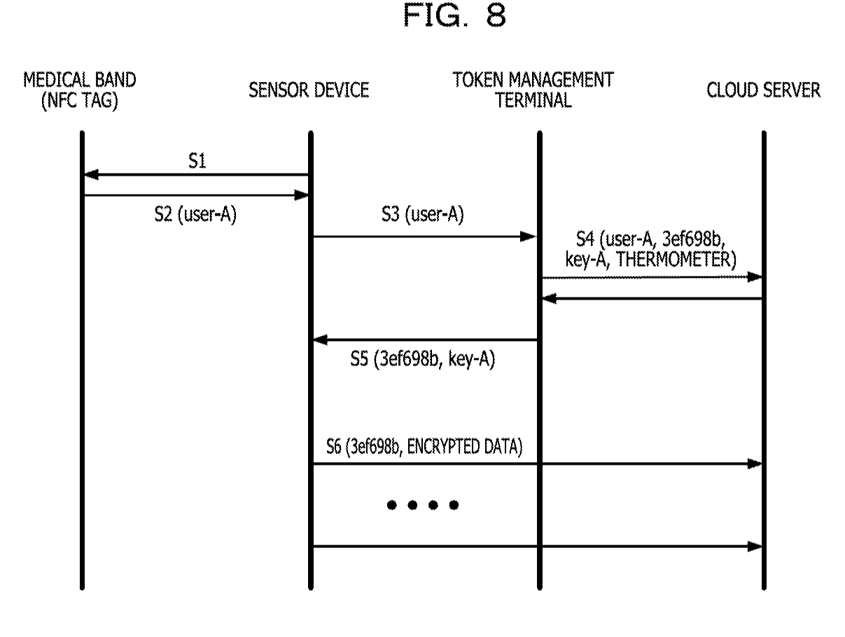

FIG. 8 is a diagram illustrating an example of a sequence in which monitor information is acquired using a sensor device and is transmitted to a cloud server, and illustrates the contents that have been described with reference to FIG. 7 in a sequence diagram. Each of processes of S1 to S6 in FIG. 8 corresponds to the corresponding one of the processes of S1 to S6 illustrated in FIG. 7.

First, the sensor device 100 performs a short-range wireless communication using the NFC tag 110 mounted in a medical band worn by a patient and NFC (S1) and acquires information of the user ID (“user-A”) from the NFC tag 110 (S2). The sensor device 100 transmits a token generation request with the acquired information of the user ID to the token management terminal 200 (S3). The sensor device 100 may be configured to transmit, in that case, the device ID that identifies the self-device with the token generation request to the token management terminal 200.

The token management terminal 200 generates a token including an encryption key and a token ID that correspond to the user ID. The token management terminal 200 transmits the generated token with the user ID and the information of the sensor to the cloud server 30 (S4). In that case, the token management terminal 200 performs a communication with the cloud server 30 by performing an encrypted communication, such as SSL or the like, and notifies the cloud server 30 of the information of the user ID.

When the token management terminal 200 receives a response from the cloud server 30, the token management terminal 200 transmits the generated token to the sensor device 100 (S5). In that case, the token management terminal 200 transmits the generated token with information (for example, the device ID) that identifies the sensor device 100 of a destination.

The sensor device 100 encrypts measurement data measured from the patient using the encryption key included in the token received from the token management terminal 200 and transmits the encrypted data with the token ID to the cloud server 30 (S6). When data, such as, for example, an electro cardiogram or the like, is continuously measured from a patient, regularly measured data is encrypted using the same encryption key and the encrypted data is transmitted with the token ID to the cloud server 30.

[Flow Chart]

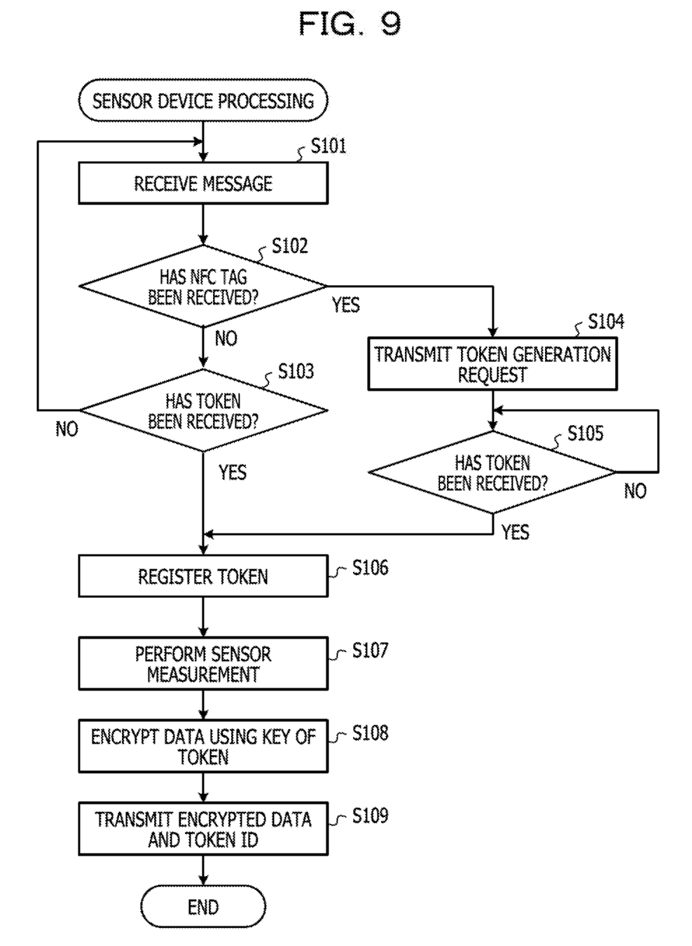

FIG. 9 is a flowchart illustrating an example of processing that is performed by a sensor device. The sensor device 100 receives a message from the NFC tag 110 or the token management terminal 200 via the NFC communication line or the BLE communication line (S101).

When the sensor device 100 receives a message, the sensor device 100 determines whether or not the received message is a message that has been received from the NFC tag 110 (S102). If the received message is not a message that has been received from the NFC tag 110 (NO in S102), the sensor device 100 determines whether or not the received message is a token that has been transmitted from the token management terminal 200 to the self-device (S103). If the received message is not a token that has been transmitted to the self-device (NO in S103), it is assumed that the received message is not a message that is to be processed by the sensor device 100, the process returns to S101, and the sensor device 100 waits until receiving a next message.

If the message received by the sensor device 100 is the user ID that has been received from the NFC tag 110 (YES in S102), the sensor device 100 transmits a token generation request with the received information of the user ID to the token management terminal 200 (S104). Then, the sensor device 100 waits until a token that corresponds to the transmitted token generation request is returned from the token management terminal 200 (NO in S105). When the sensor device 100 receives the generated token from the token management terminal 200 (YES in S105), the process proceeds to S106. On the other hand, also, if the message received by the sensor device 100 is a token that has been received from the token management terminal 200 (YES in S103), the process proceeds to Step S106.

In S106, the token (the encryption key, the token ID) that has been received from the token management terminal 200 is stored (registered) in the token storage unit 160. Then, the sensor device 100 performs a measurement of the body temperature or the like from the patient using the sensor 103 (S107). The sensor device 100 encrypts measurement data acquired by the measurement using the encryption key included in the token that has been received from the token management terminal 200 and generates encrypted data (S108). The sensor device 100 transmits the generated encrypted data with the token ID to the cloud server 30 (S109).

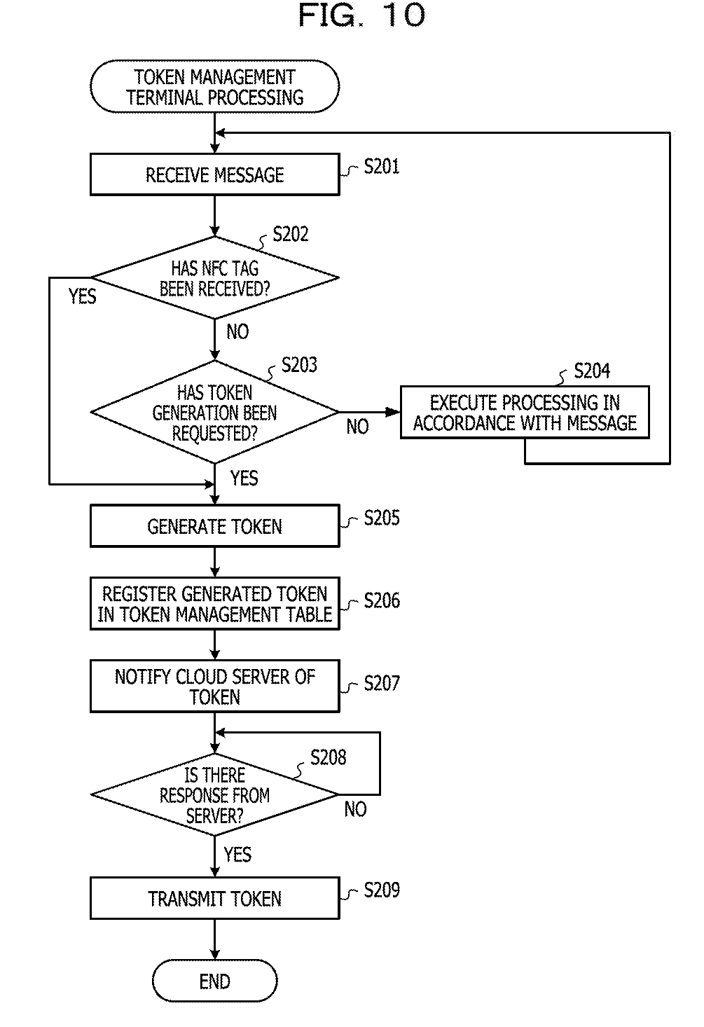

FIG. 10 is a flowchart illustrating an example of processing that is performed by the token management terminal 200. The token management terminal 200 receives a message via the NFC communication line and the BLE communication line (S201).

When the token management terminal 200 receives a message, the token management terminal 200 determines whether or not the received message is a message that has been received from the NFC tag 110 (S202). If the received message is not a message that has been received from the NFC tag 110 (NO in S202), the token management terminal 200 determines whether or not the received message is a token generation request that has been received from the sensor device 100 (S203). If the received message is not a token generation request either (NO in S203), the token management terminal 200 performs processing in accordance with the received message (S204), and the process proceeds to S201.

If a user ID is received from the NFC tag 110 (YES in S202) or if a token generation request is received from the sensor device 100 (YES in S203), the token management terminal 200 generates a token that corresponds to the received user ID (S205). The token management terminal 200 registers (stores) the generated token (the encryption key, the token ID) in accordance with the received user ID with information, such as the identification information of the sensor device 100 coupled thereto via the BLE line, or the like, in the token management table 260 (S206).

The token management terminal 200 notifies the cloud server 30 of the token and the information of the sensor device 100 that have been registered in the token management table 260 (S207) and waits until a response from the cloud server 30 is returned (NO in S208). When the token management table 260 receives a response from the cloud server 30 (YES in S208), the token management table 260 transmits the generated token (the encryption key, the token ID) to the sensor device 100 (S209).

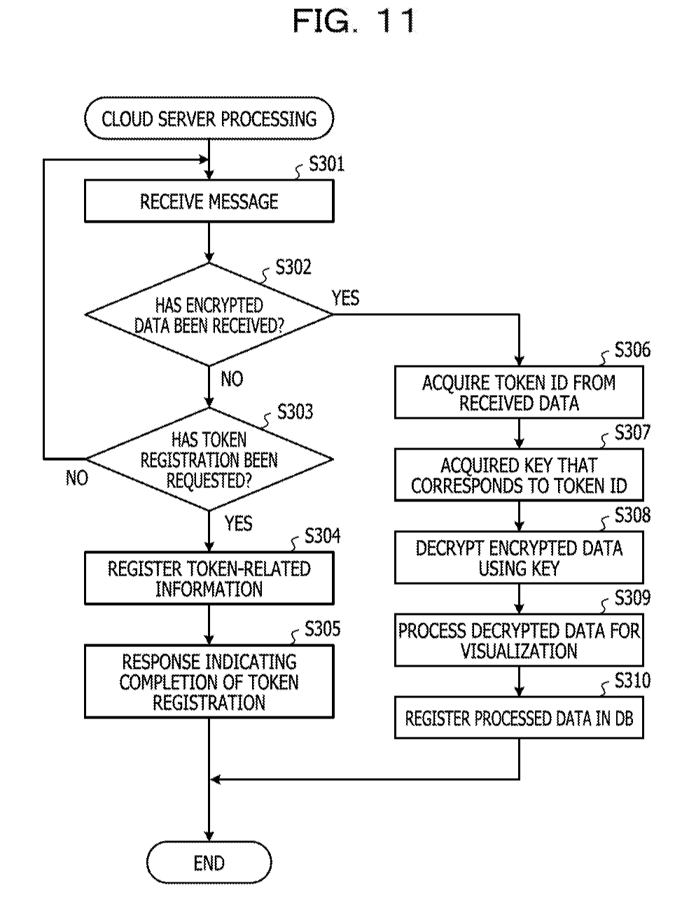

FIG. 11 is a flowchart illustrating an example of processing that is performed by the cloud server 30. The cloud server 30 receives a message via the network 40 (S301). A message that is received includes, for example, a token registration request that has been generated by the token management terminal 200 or encrypted data that has been generated by the sensor device 100.

When the cloud server 30 receives a message, the cloud server 30 determines whether or not the received message is encrypted data that has been generated by the sensor device 100 (S302). If the received message is not encrypted data (NO in S302), the cloud server 30 determines whether or not the received message is a token registration request that has been generated by the token management terminal 200 (S303). If the received message is not a token registration request either (NO in S303), the process returns to S301.

If the received message is a token registration request (YES in S303), the cloud server 30 registers information related to a token included in the token registration request in the cloud service table 360 (S304). Then, the cloud server 30 transmits a response indicating that registration of a token is completed to the token management terminal 200 (S305).

On the other hand, if the received message is encrypted data that has been generated by the sensor device 100 (YES in S302), the token ID that has been received with the encrypted data is acquired from the received message (S306). The cloud server 30 acquires information of an encryption key that corresponds to the acquired token ID from the cloud service table 360 (S307). Then, the cloud server 30 decrypts the received encrypted data using the corresponding encryption key (S308).

The cloud server 30 processes the decrypted measurement data of the patient for visualization, as appropriate (S309), and registers the processed data in the database 310 (S310).

### Advantages of First Embodiment

As described above, in the first embodiment, when biological information, such as body temperature or the like, of a patient is acquired using the sensor device 100, the token management terminal 200 generates a token (an encryption key, a token ID) that corresponds to a user ID that identifies a patient that is a measurement target separately from identification information of the patient. The token management terminal 200 transmits the generated token to both of the cloud server 30 and the sensor device 100. The sensor device 100 encrypts measurement data measured from the patient using the encryption key included in the token and transmits the corresponding token ID, not a user ID that directly specifies the patient, with the encrypted data to the cloud server.

The cloud server 30 specifies the corresponding encryption key which has been received in advance from the token ID that has been received with the encrypted data and decrypts the received encrypted data using the specified encryption key. Thus, in the first embodiment, the measurement data is encrypted using the encryption key that has been generated in accordance with the user ID and the encrypted data and the patient are linked to one another using the token ID that has been generated as separate identification information from the user ID that directly specifies the patient of a measurement target. In that case, also when a communication line through which an encryption communication by paring or the like is not performed and which has not been encrypted is used, data that has been encrypted in advance may be transmitted, and therefore, it is enabled to safely transmit the data. Therefore, the measurement data may be safely transmitted to the cloud server 30 from the sensor device 100.

Also, each time biological information, such as body temperature or the like, is measured from a patient using the sensor device 100, a specific token is issued by the token management terminal 200 coupled to the sensor device 100. Thus, a different token ID and a different key are used each time measurement data is encrypted and thus transmitted, and therefore, it is enabled to transmit the measurement data more safely.

### Second Embodiment

In the first embodiment, an embodiment in which it is assumed that, when a measurement for a patient that is a monitor target is performed using the sensor device 100, a person (a nurse or the like) who performs a measurement carries the token management terminal 200 has been described. However, depending on cases, there may be a case where a person (a nurse or the like) who performs a measurement for a patient using the sensor device 100 does not carry the token management terminal 200. Also, when a patient is transported to an emergency room of a hospital, or the like, a case where an NFC tag that is allocated to the patient has not been prepared may be assumed. Therefore, in a second embodiment, an example of a configuration used for, even under a different condition from that of the first embodiment, performing a measurement using the sensor device 100, encrypting measurement data, and transmitting the encrypted measurement data to the cloud server 30 will be described.

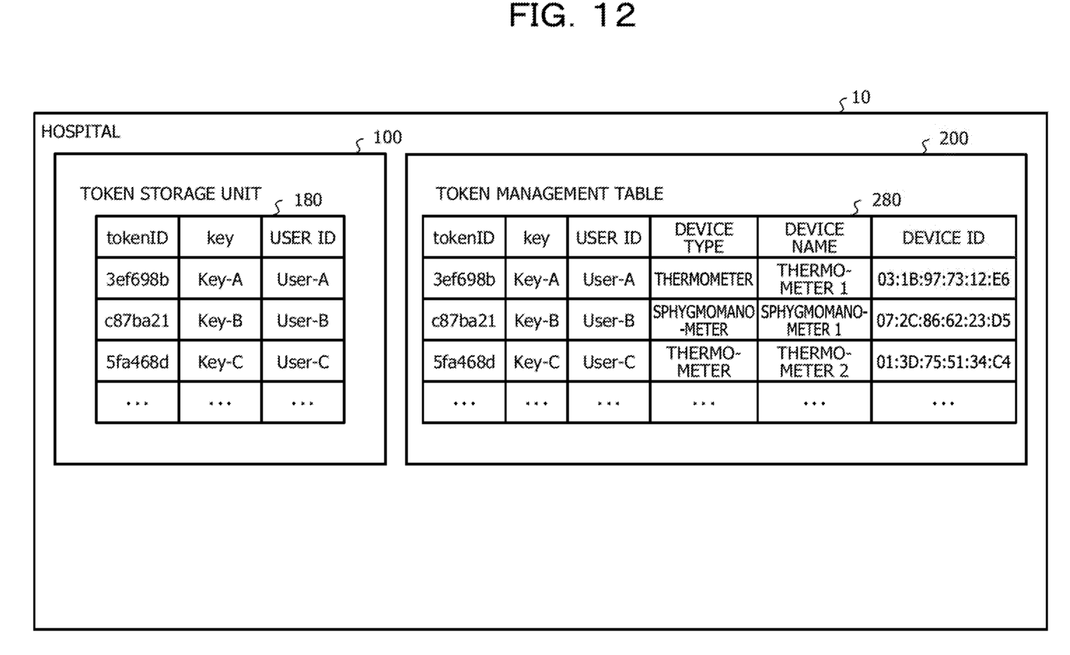

FIG. 12 is a diagram illustrating an example of a token storage unit and a token management table according to the second embodiment. In the second embodiment, the sensor device 100 includes a token storage unit 180 and the token management terminal 200 includes a token management table 280. The token storage unit 180 is stored, for example, in the nonvolatile memory 107. The token management table 280 is stored, for example, in the SSD 203.

Information of a plurality of token IDs, encryption keys, and user IDs is registered in the token storage unit 180 included in the sensor device 100. The token storage unit 180 stores information of a token ID and an encryption key that was received last from the token management terminal 200 in association with each user ID. If, when the sensor device 100 receives a token from the token management terminal 200, there is a token associated with a user ID that corresponds to the received token in the token storage unit 180, the sensor device 100 overwrites an old token with a newly received token. If there is not a token associated with a user ID that corresponds to the received token in the token storage unit 180, the sensor device 100 adds the received token as a new token to the token storage unit 180.

Similarly, the token management table 280 included in the token management terminal 200 stores information of a newest token issued to each sensor device 100. If, when the token management terminal 200 generates a new token, there is a token that corresponds to the same user ID in the token management table 280, the token management terminal 200 overwrites the token and, if not, adds the token as a new token.

A method for removing information stored in the token storage unit 180 may be performed by various methods. For example, a configuration in which, when the sensor device 100 includes an input device, such as a reset button or the like, a person who uses the sensor device 100 presses the reset button to initialize or remove the information stored in the token storage unit 180 may be employed. Also, a configuration in which information related to a token stored in the token storage unit 180 is removed in accordance with a message of a token removal request that has been received from the token management terminal 200 may be employed. Similarly, a configuration in which, also for information of a token stored in the token management table 280, information registered in the token management table 280 may be removed based on information input by a person who uses the token management terminal 200, or the like may be employed.

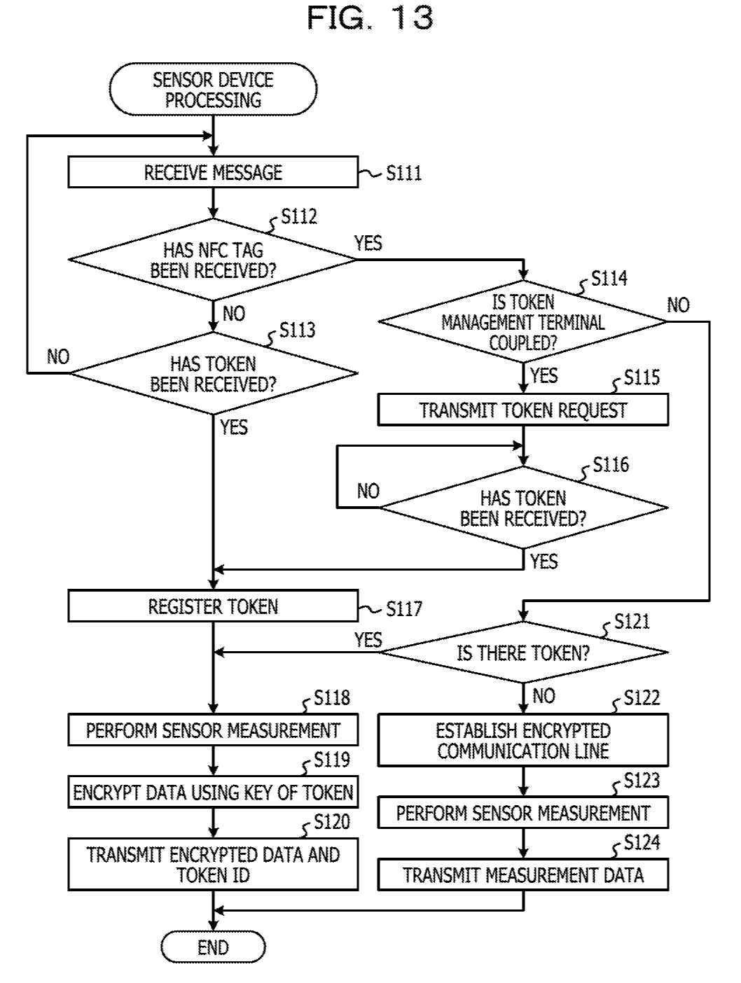

FIG. 13 is a flowchart illustrating an example of processing that is performed by a sensor device according to the second embodiment. The sensor device 100 receives a message from the NFC tag 110 or the token management terminal 200 via the NFC communication line or the BLE communication line (S111).

When the sensor device 100 receives a message, the sensor device 100 determines whether or not the received message is a message that has been received from the NFC tag 110 (S112). If the received message is not a message that has been received from the NFC tag 110 (NO in S112), the sensor device 100 determines whether or not the received message is a token that has been transmitted to the self-device from the token management terminal 200 and received (S113). If the received message is not a token that has been transmitted to the self-device and received (NO in S113), it is assumed that the received message is not a message that is to be processed by the sensor device 100, the process returns to S111, and the sensor device 100 waits until receiving a next message. If the received message is a token that has been transmitted to the self-device and received (YES in S113), the process proceeds to S117.

If a message received by the sensor device 100 has a user ID that has been received from the NFC tag 110 (YES in S112), the connection determination unit 155 refers to the management terminal connection state table 170 and determines whether or not the token management terminal 200 is coupled thereto (S114). If it is determined that the token management terminal 200 is coupled thereto (YES in S114), a token generation request is transmitted with the user ID to the token management terminal 200 (S115).

The sensor device 100 waits until receiving the generated token from the token management terminal 200 (NO in S116) and, when the sensor device 100 receives the generated token (YES in S116), registers the generated token in the token storage unit 180 (S117). If a token that was generated for the same user ID before is already registered in the token storage unit 180, the token stored in the token storage unit 180 is overwritten with the token newly received from the token management terminal 200.

When the generated token is registered in the token storage unit 180, the sensor device 100 performs a measurement for a measurement target using the sensor 103 (S118). When measurement data is acquired from the measurement target by a measurement, the sensor device 100 encrypts the measurement data using an encryption key included in the token registered in the token storage unit 180 (S119). The sensor device 100 transmits encrypted data acquired by encrypting the measurement data with the token ID included in the token registered in the token storage unit 180 to the cloud server 30 (S120). The BLE communication unit 152 transmits the encrypted data to the gateway 120 and the gateway 120 transmits the encrypted data to the cloud server 30 via the network 40, thereby performing transmission of the encrypted data.

On the other hand, if it is determined in the determination of S114 that the token management terminal 200 is not coupled thereto (NO in S114), whether or not the token that corresponds to the user ID received from the NFC tag 110 is stored in the token storage unit 180 (S121). If it is determined that the token that corresponds to the user ID is stored in the token storage unit 180 (YES in S121), the sensor device 100 executes processes of S118 to S120.

In the determination of S121, if it is determined that the token that corresponds to the user ID is not stored in the token storage unit 180 (NO in S121), the sensor device 100 performs processing of establishing an encrypted communication path with the gateway 120 by the BLE communication unit 152 (S122). The processing of establishing an encrypted communication path is performed by, for example, processing of paring in which an encryption key is exchanged, or the like. Thereafter, the sensor device 100 performs a measurement using the sensor 103 (S123) and transmits the acquired measurement data to the cloud server 30 via the encrypted communication path that has been established in S122 (S124).

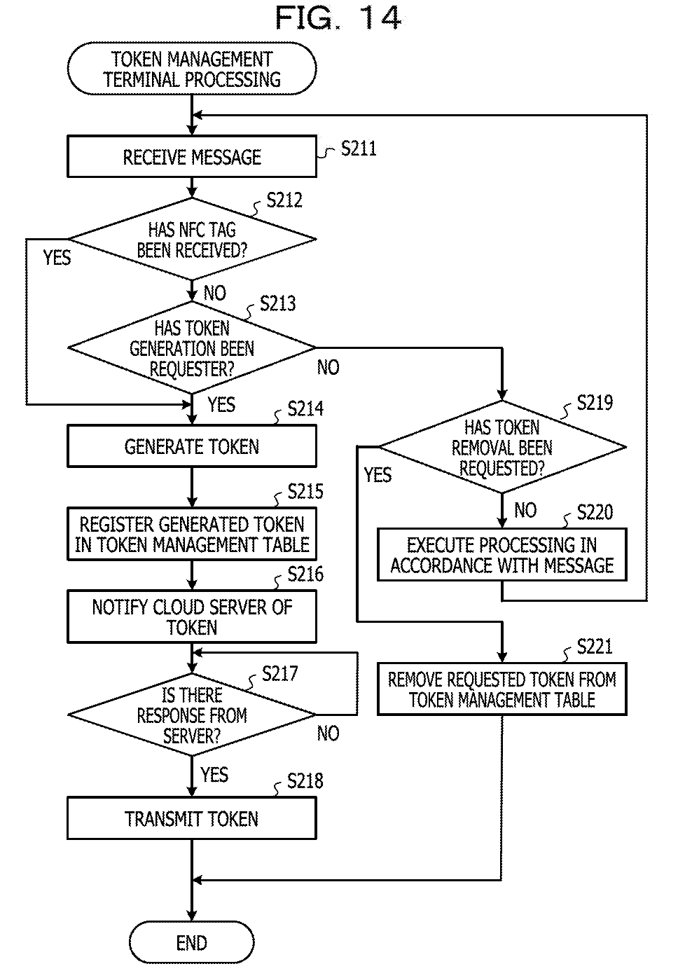

FIG. 14 is a flowchart illustrating an example of processing that is performed by a token management terminal according to the second embodiment. The token management terminal 200 receives a message via the NFC communication line or the BLE communication line (S211). Also, the token management terminal 200 receives a message related to an operation, or the like, input by an operator via an input device, such as a touch panel or the like (S211).

When the token management terminal 200 receives a message, the token management terminal 200 determines whether or not the received message is a message that has been received from the NFC tag 110 (S212). If the received message is a user ID that has been received from the NFC tag 110 (YES in S212), the token management terminal 200 generates a new token that corresponds to the received user ID (S214) and registers the generated token in the token management table 280 (S215). If, when the generated token is registered in the token management table 280, a token that was generated for the same user ID before is stored, the token management terminal 200 overwrites the token that was generated before with the newly generated token.

When the generated token is registered in the token management table 280, the token management terminal 200 notifies the cloud server 30 of the generated token (S216) and waits for a response from the cloud server 30 (NO in S217). When the token management terminal 200 receives a response that notifies that the transmitted token has been correctly received at the cloud server 30 (YES in S217), the token management terminal 200 transmits the generated token to the sensor device 100 (S218) and terminates the process.

On the other hand, if it is determined in the determination of S212 that the received message is not a message that has been received from the NFC tag (NO in S212), the token management terminal 200 determines whether or not the received message is a token generation request (S213). If the received message is a token generation request that has been received with information of the user ID from the sensor device 100 (YES in S213), processing of generating a token that corresponds to the received user ID and transmitting the generated token (S214 to S218).

If, in the determination of S213, the received message is not a token generation request either (NO in S213), the token management terminal 200 determines whether or not the received message is a token removal request that has been input by the operator of the token management terminal 200 (S219). If the input message is not a token removal request either (NO in S219), processing in accordance with the received message is executed (S220) and the process returns to S211.

If, in the determination of S219, it is determined that the received message is a token removal request (YES in S219), the token management terminal 200 performs processing of removing a token requested by the token removal request from the token management table 280 (S221). The token removal request includes, for example, information of the token ID or the user ID which is related to a token that is to be a removal target. The information of the token ID, the user ID, or the like which is related to a token that is to be a removal target, is input, for example, by an arbitrary method, such as input via the touch panel of the token management terminal 200, or the like.

### Advantages of Second Embodiment

As described above, when the sensor device 100 according to the second embodiment receives a user ID from the NFC tag 110, the sensor device 100 checks a connection condition of the token management terminal 200. If the token management terminal 200 is coupled thereto, the sensor device 100 requests the token management terminal 200 to generate a new token, encrypts measurement data using the newly generated token, and transmits the encrypted data to the cloud server 30. Accordingly, if the token management terminal 200 is coupled to the sensor device 100, the sensor device 100 is capable of performing encryption, and thus, transmission of data using a new token at all times and safely transmit measurement data to the cloud server 30.

Also, even in a condition in which the token management terminal 200 is not coupled to the sensor device 100, if a token that corresponds to the user ID is stored in the token storage unit 180, the token stored in the token storage unit 180 is used. In this case, it is possible to encrypt measurement data using a token generated at the time of a measurement in the past and thus transmit the encrypted measurement data to the cloud server 30.

In a state where there is not the token management terminal 200 near a person (a nurse or the like) who uses the sensor device 100, when an emergency patient is transported by an ambulance car or when a first medical examination of a patient is performed, the token management terminal 200 is not capable of generating a token that corresponds to the new patient. Therefore, if there is not the token management terminal 200 near the sensor device 100, an encrypted communication line with the gateway 120 is established by a method, such as paring or the like, and thereby, the sensor device 100 is enabled to transmit the measurement data to the cloud server 30. In that case, even when there is not information of the user ID, the measurement data is transmitted with the identification information of the sensor device 100 to the cloud server 30 and is stored with a reception time of the measurement data in the database 310 at the cloud server 30 side, and thereby, it is possible to check a measurement result later.

Preferred embodiments have been described in detailed above, but the present disclosure is not limited to specific embodiments and various modifications and changes may be made to those embodiments, as described below.

(1) Another Example of Hardware Configuration of Sensor Device

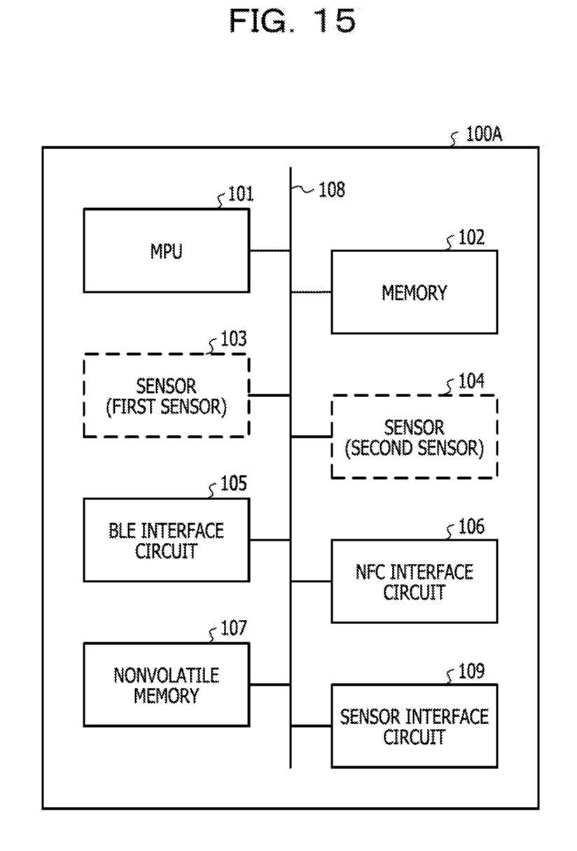

FIG. 15 is a diagram illustrating another example of a hardware configuration of a sensor device. A sensor device 100A of FIG. 15 includes a sensor interface circuit 109 used for coupling to some other sensor than the first sensor 103 and the second sensor 104. In this case, a configuration in which the first sensor 103 and the second sensor 104 are not mounted in the sensor device 100A may be employed.

The sensor interface circuit 109 is an interface circuit that performs transmission and reception of a signal in accordance with a specific communication protocol or bus standard and thereby couples to a sensor. As an example of the sensor interface circuit 109, for example, a communication interface circuit, such as a universal serial bus (USB), BLE, or the like, may be used. The sensor device 100A includes the sensor interface circuit 109 of FIG. 15, and thereby, an existing sensor including a specific communication interface may be used. Therefore, a sensor device that corresponds to the sensor device 100 of the first embodiment may be achieved by coupling the existing sensor to the sensor interface circuit 109 of the sensor device 100A.

(2) Example in which Token is Generated in Cloud Server 30

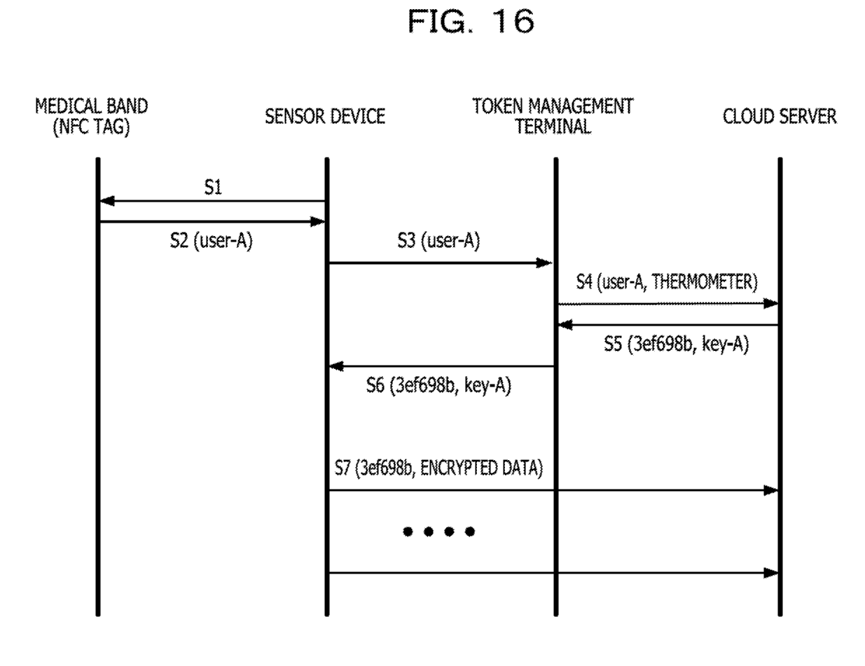

FIG. 16 is a diagram illustrating an example of a sequence when the cloud server 30 issues a token (a token ID and an encryption key) which corresponds to a user. In the first embodiment or the second embodiment, the token management terminal 200 generates a token that corresponds to a user ID given to the NFC tag 110 of a patient, but a configuration in which the cloud server 30 generates a token, as illustrated in FIG. 16, may be employed. In FIG. 16, processes of S1 to S3 are similar to the processes of S1 to S3 in FIG. 8, and therefore, the description thereof will be omitted.

In FIG. 16, when the token management terminal 200 acquires information of the user ID of a patient by performing the processes of S1 to S3, the token management terminal 200 notifies the cloud server 30 of the acquired information of the user ID and information related to the sensor device 100 that is used for measuring data for the patient. In this case, the token management terminal 200 performs a communication with the cloud server 30 by performing an encrypted communication, such as SSL or the like, and notifies information of the user ID to the cloud server 30 (S4). The cloud server 30 generates a token including a specific encryption key and a token ID, based on the user ID and information related to the sensor device 100, which have been received, and transmits the generated token to the token management terminal 200 (S5).

The token management terminal 200 transmits the token received from the cloud server 30 to the sensor device 100 (S6). When the sensor device 100 receives the token from the token management terminal 200, the sensor device 100 starts a measurement for the patient, encrypts a measurement result using an encryption key included in the token, and transmits the encrypted measurement result with the token ID to the cloud server 30 (S7). Thus, tokens of users may be centrally managed at the cloud server 30 side.

(3) Modified Example of Token Generation Timing

In the first embodiment and the second embodiment, each time a measurement is performed, the sensor device 100 requests the token management terminal 200 to generate a new token and the token management terminal 200 that has received a token generation request generates a new token. However, as the token management table 280 in FIG. 12 illustrates, when a plurality of tokens that correspond to a plurality of users is held in the token management table 280 in advance, a token of a user may be generated or updated at an arbitrary timing.

For example, a configuration in which, once a day, at a certain determined time, for all tokens stored in the token management table 280, the token management terminal 200 changes a token ID and the contents of an encryption key and transmits the token ID and the contents of the encryption key which have been changed to the cloud server 30 in advance may be employed. Thus, processing of generating a token, transmitting the token to the cloud server 30, and waiting for a response, which is performed by the token management terminal 200 before using the sensor device 100, may be omitted.

(4) Example of Configuration in which Functions of Token Management Terminal 200 are Mounted in Gateway

For example, when the gateway 120 is installed in each of all rooms in a hospital, the functions of the token management terminal 200 may be mounted as they are in the gateway 120. In this case, for each gateway 120, among the hardwares illustrated in FIG. 3, the WiFi interface circuit 205 may be replaced with a network interface circuit 209 (not illustrated). The network interface circuit 209 is an interface circuit that performs a communication with another device via the network 40.

The gateway 120 in which the functions of the token management terminal 200 are mounted is used, and thus, even when a person (a nurse or the like) who uses the sensor device 100 does not carry the token management terminal 200, a token that corresponds to a user ID may be registered in the sensor device 100. Also, the gateway 120 in which the functions of the token management terminal 200 are mounted is used, and thus, a patient in each hospital room may voluntarily hold the NFC tag 110 over an NFC tag reader part (which corresponds to the NFC interface circuit 206 in FIG. 3) of the gateway 120 and perform a measurement using the sensor device 100.

(5) Others

A program that causes the computer 300 to execute each of the processes in the sensor device 100, the token management terminal 200, and the cloud server 30, which have been described above, may be stored in a computer-readable recording medium. As a recording medium, for example, a magnetic disk, an optical disk, a magneto-optical disk, a semiconductor memory, or the like may be used. Examples of a magnetic disk include a HDD and the like. Examples of an optical disk include a compact disc (CD), a CD-recordable (R)/rewritable (RW), a digital versatile disc (DVD), a DVD-R/RW, and the like.

Note that distribution of a program according to the present disclosure is not limited to distribution using the above-described recording medium, and a program may be transmitted via a network or the like, represented by a telecommunication line, a wireless or wired communication line, and the Internet, is stored in a recording medium, such as a HDD or the like, and thus, is used.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
an information processing device including a memory and a processor coupled to the memory;
an electronic tag configured to store first identification information used for identifying a monitor target; and
a sensor device configured to acquire first monitor information of the monitor target,
wherein
the processor is configured to:
transmit, to the sensor device and a server device, a first encryption key corresponding to the first identification information, and
transmit, to the sensor device and a server device, second identification information used for identifying the first encryption key, and
the sensor device is configured to:
acquire the first identification information from the electronic tag,
encrypt the first monitor information using the first encryption key that corresponds to the first identification information, and
transmit, to the server device, the encrypted first monitor information and the second identification information.

2. The information processing system according to claim 1, wherein the server device is further configured to decrypt the first monitor information transmitted from the sensor device, based on the first encryption key transmitted from the information processing unit.

3. The information processing system according to claim 1, wherein
the sensor device is further configured to transmit the first identification information acquired from the electronic tag to the information processing device, and
the information processing device is further configured to generate, based on the first identification information transmitted from the sensor device, the first encryption key and the second identification information.

4. The information processing system according to claim 3, wherein the sensor device is further configured to:
when the first identification information is transmitted from the electronic tag more than two times, acquire, from the information processing device, a second encryption key and third identification information used for identifying the second encryption key, the a second encryption key corresponding to the first identification information and being different from the first encryption key,
acquire second monitor information of the monitor target, and
encrypt the second monitor information using the second encryption key.

5. The information processing system according to claim 4, wherein the sensor device is further configured to:
determine whether it is possible to be coupled to the information processing device via a communication line, and
transmit, when it is determined that it is possible to be coupled to the information processing device, the first identification information to the information processing device using the communication line.

6. The information processing system according to claim 5, wherein the sensor device is further configured to:
encrypt, when it is not determined that it is possible to be coupled to the information processing device, the second monitor information using the first encryption key, and
transmit, to the server device, the encrypted second monitor information and the second identification information.

7. The information processing system according to claim 1, wherein the information processing device is further configured to transmit, before transmitting the first encryption key and the second identification information to the sensor device, the first encryption key and the second identification information to the server device.

8. A method of obtaining monitor information from a monitor target using an information processing system including an information processing device, an electronic tag storing first identification information used for identifying the monitor target, and a sensor device, the method comprising:
acquiring, by the sensor device, first monitor information of the monitor target;
transmitting, by the information processing device, to the sensor device and a server device, a first encryption key corresponding to the first identification information;
transmitting, by the information processing device, to the sensor device and a server device, second identification information used for identifying the first encryption key;
acquiring, by the sensor device, the first identification information from the electronic tag;
encrypting, by the sensor device, the first monitor information using the first encryption key that corresponds to the first identification information; and
transmitting, by the sensor device, to the server device, the encrypted first monitor information and the second identification information.

9. The method according to claim 8, further comprising:
decrypting, by the server device, the first monitor information transmitted from the sensor device, based on the first encryption key transmitted from the information processing unit.

10. The method according to claim 8, further comprising:
transmitting, by the sensor device, the first identification information acquired from the electronic tag to the information processing device; and
generating, by the information processing device, based on the first identification information transmitted from the sensor device, the first encryption key and the second identification information.

11. The method according to claim 10, further comprising:
when the first identification information is transmitted from the electronic tag more than two times, acquiring, by the sensor device, from the information processing device, a second encryption key and third identification information used for identifying the second encryption key, the a second encryption key corresponding to the first identification information and being different from the first encryption key;
acquiring, by the sensor device, second monitor information of the monitor target; and
encrypting, by the sensor device, the second monitor information using the second encryption key.

12. The method according to claim 11, further comprising:
determining, by the sensor device, whether it is possible to be coupled to the information processing device via a communication line, wherein,
when it is determined that it is possible to be coupled to the information processing device, the first identification information is transmitted to the information processing device using the communication line.

13. The method according to claim 12, further comprising:
when it is not determined that it is possible to be coupled to the information processing device, encrypting, by the sensor device, the second monitor information using the first encryption key; and
transmitting, by the sensor device, to the server device, the encrypted second monitor information and the second identification information.

14. The method according to claim 8, wherein
in the transmitting the first encryption key and in the transmitting second identification information, before transmitting the first encryption key and the second identification information to the sensor device, the first encryption key and the second identification information are transmitted to the server device.

15. A sensor device comprising:
a memory; and
a processor coupled to the memory and configured to;
acquire first monitor information of a monitor target,
obtain, from an information processing device, a first encryption key corresponding to the first identification information,
obtain, from the information processing device, second identification information used for identifying the first encryption key,
acquire first identification information used for identifying the monitor target from an electronic tag,
encrypt the first monitor information using the first encryption key that corresponds to the first identification information, and
transmit, to a server device, the encrypted first monitor information and the second identification information.

16. The sensor device according to claim 15, wherein the server device is further configured to decrypt the first monitor information transmitted from the sensor device, based on the first encryption key transmitted from the information processing unit.

17. The sensor device according to claim 15, wherein
the processor is further configured to transmit the first identification information acquired from the electronic tag to the information processing device, and
the information processing device is further configured to generate, based on the first identification information transmitted from the sensor device, the first encryption key and the second identification information.

18. The sensor device according to claim 17, wherein the processor is further configured to:
when the first identification information is transmitted from the electronic tag more than two times, acquire, from the information processing device, a second encryption key and third identification information used for identifying the second encryption key, the a second encryption key corresponding to the first identification information and being different from the first encryption key,
acquire second monitor information of the monitor target, and
encrypt the second monitor information using the second encryption key.

19. The sensor device according to claim 18, wherein the processor is further configured to:
determine whether it is possible to be coupled to the information processing device via a communication line, and
transmit, when it is determined that it is possible to be coupled to the information processing device, the first identification information to the information processing device using the communication line.

20. The sensor device according to claim 19, wherein the processor is further configured to:
encrypt, when it is not determined that it is possible to be coupled to the information processing device, the second monitor information using the first encryption key, and
transmit, to the server device, the encrypted second monitor information and the second identification information.
